(19) United States
(12) Patent Application Publication
(10) Pub. No.: US 2010/0270796 A1
(43) Pub. Date: Oct. 28, 2010

(54) Kink eliminator connector

(76) Inventor: Thomas William David Ashcroft, Granby (CA)

Correspondence Address: MS. MARIA LUBECKI, 435 ST-VALIER ST., GRANBY, QC, J2G 8Y4, CA

(21) Appl. No.: 12/662,540

(22) Filed: Apr. 22, 2010

Related U.S. Application Data
(60) Provisional application No. 61/213,018, filed on Apr. 28, 2009.

(51) Int. Cl. F16L 21/00

(52) U.S. Cl. 285/417; 138/109; 138/121

(57) ABSTRACT

A length of flexible corrugated hose of polymeric material inserted as a connector in a fluid or air-line to transmit liquids or air at a consistent flow from an intake source to an outtake receptor, while the intake and outtake ends are located at a variety of angles up to 180° to each other.

Applicant claims benefit of provisional patent application No. 61/213,018, filed on Apr. 28, 2009.

### BACKGROUND

1. Field of Invention

The present invention relates to flexible corrugated hoses of polymeric construction.

2. Prior Art Statement

Hoses of the invention are referenced in the following patents:

| | | | |
|---|---|---|---|
| 3,313,319 | April 1967 | Osborn et al. | 138/121 |
| 3,402,429 | September 1968 | Davidson et al | 18/19 |
| 3,559,692 | February 1971 | Mantelet | 138/121 |
| 3,958,425 | May 1976 | Maroschak | 138/121 |
| 4,079,757 | March 1978 | Fischer et al | 138/121 |
| 4,151,864 | May 1979 | Thurman | 138/121 X |
| 4,163,619 | August 1979 | Fales | 405/49 |
| 5,492,151 | February 1996 | Wood et al | 138/121 |
| 6,142,188 | November 2000 | Schaerfl et al | 138/121; 1238/DIG.11 |

US Class: 138/118, 138/121, 138/DIG 11,
Int. Class: F16L1111
Field of Search 138/118, 138/121, 138/DIG 11, 137/8, 137/5

### SUMMARY OF THE INVENTION

The novel use of the present invention is a device designed to prevent kinking in hoses and/or pipes, transmitting liquids or air, while maintaining a consistent and non-restrictive flow of liquids or air.

The novel use of such device is the principle object of this invention, which is to provide a dependable solution to prevent the kinking and blockage hoses, while extending their hose life. This invention, a short length of flexible corrugated hose, is fastened at each the intake end and the outtake end with a coupling appropriate for attachment to the in-going source and out-going receptor. The device is then inserted (attached) into a liquid line or air-line, connecting respectively to the intake source and the outtake receptor. An example would be as a connection inserted in between a water faucet (attaching the intake end of the invention) and a garden hose (attaching the outtake end of the invention).

The composition of the corrugated hose is of a flexible polymer, which length, size and tensile strength are suitable for the intake and outtake appliances, or, devices and their corresponding pressure. For example; normally required for connection to one end of a standard North American watering/garden hose (male fitting attached of Imperial threads), with the other end of the invention attached to a standard North American outdoor water faucet (Imperial threads), the inner diameter dimension of the flexible corrugated hose at its smooth end would be ⅝″, having an outer dimension of ¾″. The desired length of this device would be 5.425″ or shorter.

The style and shape of the corrugations of the invention may be round to angular in its crests and its valleys. The sidewalls connecting the crests and valleys may be perpendicular or up to a slight angle to the crests.

Without such invention inserted between a water faucet and a watering hose, the watering hose connected directly to the water faucet kinks at an angle of 90°. The result of such effect is that the water flow is diminished substantially, hindering the longevity of the hose as a user-friendly and a dependable watering device:

This invention replaces other faucet to hose extensions, while substantially improving their performance. The extensions, which this invention substitutes by way of its novel application, are generally short lengths of garden hose, constructed of a reinforced vinyl, and set within a wire spring formation of helix coils. Appropriate couplings are attached at each end of such extension, in order to join the extension to a faucet at one end and at the other end, to join the extension to a garden hose.

These extensions, of a short length of a garden hose inserted within a spring-like wire protector, extending from midway of one coupling to midway of the other, are stiff and not easily flexible. They almost resemble a slightly less rigid extension of the immobile water faucet itself, rather than being easily flexible and/or a solution to the kinking problems of watering hoses at the faucet. Therefore, this type of garden hose extension produces failures in performance which are described in the following examples of this type of extension, comprised of a length of 5.375″ with couplings attached, when such extension is attached between a water source, a faucet, and a watering device, such as a standard garden hose. These conditions produce the following results:
The watering garden hose kinks when the watering garden hose is held at 90° to the extension;
When the watering garden hose is held at around 135° to the faucet, the watering garden hose does not kink, but the extension itself kinks.

The result is that this type of device, comprised of a short length of garden hose set within a wire spring-like framework with the appropriate fittings attached, is poorly designed and is not only dysfunctional, but is an inefficient purchase upon the part of the user, unbeknownst to the purchaser. With these type of devices, kinking occurs invariably either in the hose itself or within the extension, thus diminishing substantially or blocking altogether the water-flow. In either of these cited examples of failure, due to the obvious kinking, the hose life of the watering garden hose or such similar extension is decreased. In that such extensions do not hinder the kinking of a watering garden hose, when the hose is held at an angle of 90° to the extension, the resulting repetitive kinking of the hose wears the garden hose, weakening its construction in the same place, eventually causing the hose to deteriorate.

In contrast to the foregoing previous art, the invention, which is used attached as a short connector from the water faucet to the watering hose, hinders kinking of either the hose or the connector up to 180°, when the watering hose is held at such an angle to the water faucet. Therefore, the novelty of this invention ensures an approximate constant and consistent flow of water, while extending the life of the watering hose itself. The user would appreciate both these aspects, and would no longer need to struggle to undo the kinks in a watering hose at the area of the faucet. Presently, kinking of a garden hose at the faucet is a frequent problem encountered, annoying the user, apart from deteriorating the hose.

The invention does not only serve as a connector at a water faucet, but can be used as a connection where problems are encountered in the flow of water or air, due to the change in direction of the flow. The following are some other examples of use:
The kink eliminator connector can be placed at intervals in a watering system, such as when two or more watering/garden hoses are attached, which are placed or used in different directions of each other, for example, around the corner of a building;
The invention can be attached at the exit of the watering hose, for example at a sprinkler, or any other device, which is moved about.
The invention could be incorporated to join semi-rigid to rigid hoses or pipes of differing rigidity together at corners, for the transference of liquids or air.

In all cases, the dimensions of the extensions and the polymer required would need to be adequate for the purpose, which includes the pressure in liquids or air. The couplings attached would be those suitable to attach this invention to the intake and outtake of liquids or air. For example, to accommodate the pressure and water flow desired for attachment between a standard faucet and a garden hose, the following would be the normal requirements meeting standard measurements of North America:
Polymer material adequate to support standard water pressure, causing constant stress, would be such materials as Nylon 11, Nylon 12, Polyurethane, PVC etc;
Desired length of the kink elimination connector: 5.425″ or shorter;
Non-corrugated section of hose: OD at 0.733″; ID at 0.713″;
Corrugated section of hose; OD at 0.900″; length of corrugation 3.365″ set at 1.030″ from each end, and including 19 crests of around 0.093″ in height, having a distance between their peaks of 0.183″;
¾″ national hose thread male coupling at one end to attach to a standard faucet;
¾″ national hose thread female coupling at the other end to attach to a Coupling of a standard garden hose. (Any coupling required to connect to the garden hose may be attached, including push-on type couplings.)

Apart from the herein described novel benefits of the invention, the kink eliminator connector is environmentally friendly. Its advantage of helping to maintain the longevity of other attachments, such as a watering hose, which have standard lengths of 15, 25 and 50 feet, etc. hinders these products from deteriorating and being disposed of unnecessarily. This invention of the kink eliminator connector prevents repetitive kinking which destroys a small part of a hose, while the remainder is of good and useable condition.

Many users do not refit couplings onto the remainder of a garden hose which remains in good condition and which has not been damaged by continual kinking, but toss the complete product into the waste system, thus compounding the burden upon the environment. An invention such as the kink eliminator connector would lessen such premature burden upon the environment.

### DETAILED DESCRIPTION OF THE INVENTION

Comprehension of this invention can be better understood through reference to the drawings along with a review of the following explanation.

The construction of the corrugated hose is not part of the invention and is referenced in former patents, as exampled in the prior art. The hose may be produced to present manufacturing principles of the formation of corrugated hoses, while maintaining a non-corrugated section at each end of each length. The shape of the corrugations, which have crests and valleys, may be rounded; flat, or angular in shape. The configurations and dimensions of the corrugations are such that the hose produced, from suitable polymer for its purpose, meet the specifications required to obtain a bend and flexible radius of up to 180° or more. The dimensions herein cited in the above extension kink protector hose of a 0.716″OD hose, produced from Nylon 11 or 12 are an example for the requirements in the flexibility of 180° required for a kink eliminator connector inserted between a water faucet and a garden hose.

The invention is not expressly aligned with non-reinforced hoses of a single layer, but may be of any configuration of construction, such as multi-layer, reinforced etc. corrugated type hose. Because numerous modifications may be made to this invention without departing from the spirit thereof, the scope of the invention is not limited to the examples described herein and/or illustrated herein.

The scope of the invention is interpreted by the appended claims and their equivalents.

### BRIEF DESCRIPTION OF THE DRAWINGS

FIG. 1 is a side elevational view of the flexible device in a straight position, showing the corrugated section (12), the smooth section coupled (11), the female coupling (14) at one end and the male coupling (10) at the other end;

FIG. 2 is a horizontal elevational view in a straight position of the flexible device of FIG. 1;

FIG. 3 is a horizontal elevational view in a straight position of the flexible device of FIG. 1, opposite to that of FIG. 2;

FIG. 4 is a side elevational view of the device of FIG. 1 in a curved position (13), showing the capacity of the device in maintaining an approximate constant flow of fluids or air;

FIG. 5 is a similar view as FIG. 1, without couplings attached;

FIG. 6 is a similar view as FIG. 2 without couplings attached;

FIG. 7 is a similar view as FIG. 3 without couplings attached;

FIG. 8 is a similar view as FIG. 4 without couplings attached.

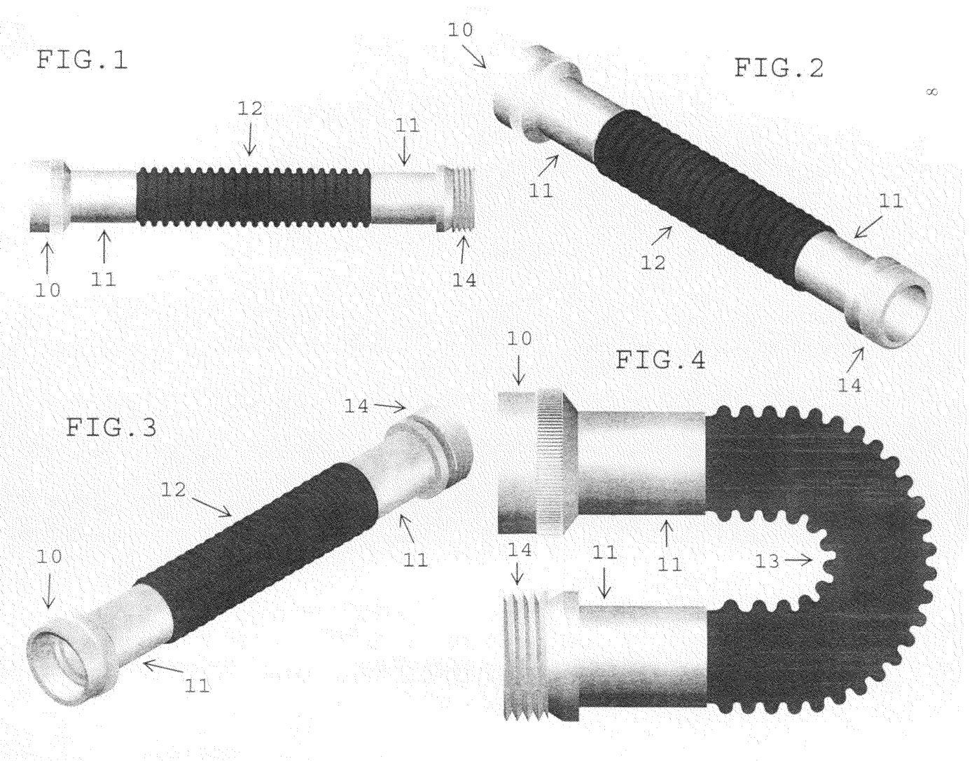

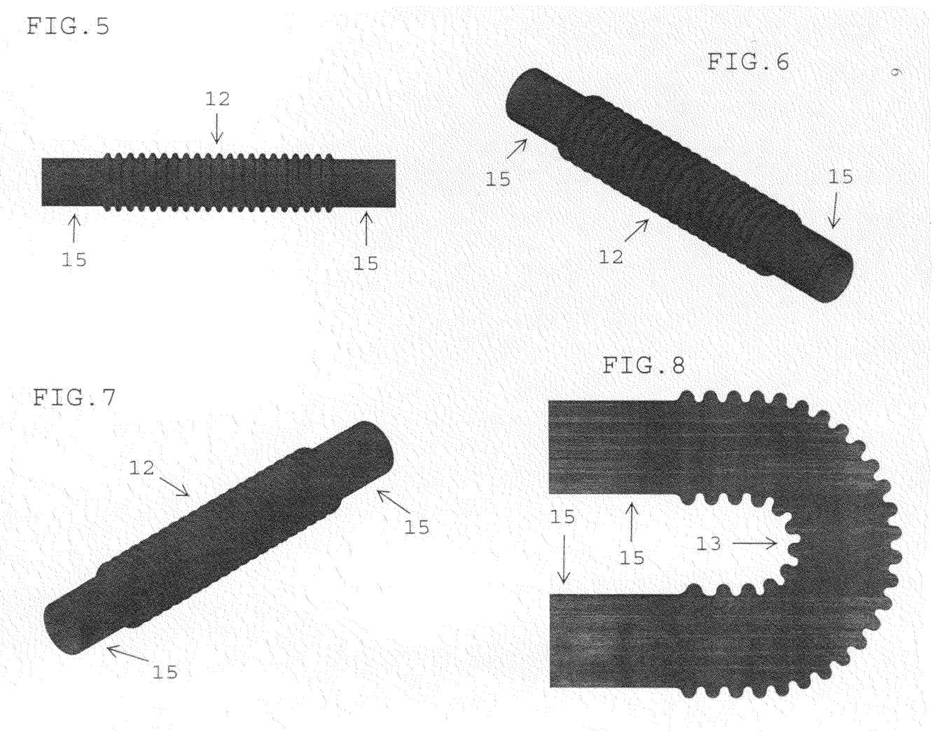

What is claimed is:

1. A flexible connector of corrugated hose comprising of a smooth section at each end;

2. A connector of claim 1 constructed out of a polymeric material resilient for the requirement of transferring under pressure liquids or air, while retaining its strength and its specifications, other than the opening and closing of the corrugations of the hose, when bent or twisted;

3. A connector of claim 2 which dimensions of its smooth/non-corrugated sections at either end are of adequate dimensions, including length, to adapt to couplings required for attachment to the liquid and/or air source at one end, and to the respective outtake source at the other end;

4. A connector of claim 3 which accommodates a minimum bend radius up to 180° while maintaining its approximate measurements of the outer diameter and the inner diameter dimensions, with marginal changes in its overall length, corresponding to the difference in dimension between each of the corrugations opened at the exterior side in relation to the opposite side of each of these crests closed at the interior side;

5. A connector of claim 4 used as a method in conjunction with other apparatus to maintain an approximate constant flow in the transference of liquids and/or air up to a bend capacity of 180°.
